(19) United States
(12) Patent Application Publication
(10) Pub. No.: US 2026/0120692 A1
(43) Pub. Date: Apr. 30, 2026

(54) EFFICIENT HUMAN-TO-MACHINE AND MACHINE-TO-HUMAN VOICE TRANSMISSION

(71) Applicant: Synthetic Media Processing Laboratory Pte. Ltd., Singapore (SG)

(72) Inventor: Koen Bernard Vos, Singapore (SG)

(73) Assignee: Synthetic Media Processing Laboratory Pte. Ltd., Singapore (SG)

(21) Appl. No.: 19/361,528

(22) Filed: Oct. 17, 2025

Related U.S. Application Data
(60) Provisional application No. 63/711,871, filed on Oct. 25, 2024.

(51) Int. Cl. G10L 15/22; G06N 3/0455; G10L 13/00; G10L 19/00

(52) U.S. Cl. CPC G10L 15/22; G06N 3/0455; G10L 13/00; G10L 19/00

(57) ABSTRACT

A human-to-machine transmission system and a machine-to-human transmission system includes a non-linear encoder that converts data representing an utterance into a frequency spectrum representing an aural range. An encoder in the human-to-machine transmission system that converts the output of the non-linear decoder into a bitstream and a decoder converts the bitstream into the frequency spectrum. An automatic speech recognition engine of the human-to-machine transmission system processes an output of the decoder to deliver an output. The machine-to-human transmission system includes a language model that replies to inquiries and a neural network that converts the text-to-speech received from a text-to-speech engine. It also includes a decoder that converts an input into the frequency spectrum, a vocoder that converts the frequency spectrum into audio frames, and a loudspeaker that converts the audio frame into audible sound.

### 1. PRIORITY CLAIM

This application claims the benefit of priority from U.S. Provisional Application No. 63/711,871, filed Oct. 25, 2024, titled “Efficient Human-to-Machine and Machine-to-Human Voice Transmission,” which is incorporated herein by reference in its entirety.

### 3. TECHNICAL FIELD

This disclosure relates to speech-coders and specifically to speech coding and voice synthesis.

### 4. RELATED ART

Speech coding and synthesis converts speech into digital representations and then reconstructs it. Processors are used to transmit and process speech. For these operations, the increasing speed of processors has created some speech coding applications, but many are restricted by coder attributes. Bit rates, speech quality, computational complexity, memory requirements, and bandwidth are a few attributes restricting speech-coding.

Codecs strive to reduce bit rates. Bit rates determine the bandwidths required to transmit speech and the memory required to process it. With decreasing bit rates, the quality of some coders declines, forcing them to become more dependent on the characteristics of their input signals. To operate in real-time, some codecs are highly complex making them costly to produce and expensive to operate due to their high power consumptions. Further, some codecs deliver bit streams corrupted by burst errors and random errors. When frames are deemed unusable, the codecs become unstable generating random and unpredictable signals that lack a discernable structure.

### DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is an exemplary distributed human-to-machine communication system using a tiered compression system.

FIG. 2 is an exemplary machine-to-human communication system using a tiered compression system.

### DETAILED DESCRIPTION

A tiered compression system transmits, stores, manipulates, detects, processes and/or generates speech. In a digital domain, the system mitigates distortion and facilitates processing by targeting different aspects of speech by a hybrid combination of one, two, or more lossy and lossless compressions. Using a cascade compression engine that may interface or comprise a unitary part of an encoder, the tiered compression system maps frequencies to a non-linear perceptual scale that may be tokenized by an optional tokenized module and then further compressed, packetized, and transmitted through a communication channel or network using a transmission protocol such as a Transmission Control Protocol/Internet Protocol. The transmission protocol governs the breakup of the multi-tiered compressed data into packets that are sent, reassembled, and verified when messages are received at their intended destinations.

In an exemplary human-to-machine application, an initial compression stage of the compression engine reduces digital data and/or file sizes by discarding or permanently removing, flattening, and/or deleting some data that is less important and/or redundant to other data. In a speech coding, for example, the other data may comprise the literal words that are spoken without some of the pitch data (fundamental frequency), loudness data (intensity) and/or some of the duration data (speech rate and timing) that conveys the speech. In a speech-to-text engine, for example, some of the cascade compression engines remove environmental sounds, noise, and/or some of the prosodic features of speech. Prosodic features may comprise data representing rhythm, pitch, loudness and/or timing, for example. Prosodic data may convey information about speaker's surroundings, emotions (e.g., data that reflects a user's acoustic, visual, physiological, behavioral state) or emphasis that makes it easier for a listener to interpret spoken communication but is not always necessary to convey meaning to computer applications, such artificial intelligence, and/or neural networks. Other examples of prosodic data include data that conveys other features of speech (e.g. intonation, stress, and/or rhythm), data that conveys voice quality (e.g., tremors, harshness, and/or breathiness), data reflecting special expressions, micro expressions including eye gaze or movement patterns, physiological signals (e.g., heart rate, respiration, skin conductance, and/or brainwave activity), behavioral interactions (e.g., typing cadence, audio cadence, response latency), and/or linguistic features (e.g., word choice, sentiment). When some prosodic features or other speech/environmental segments are necessary, selected speech/environmental segments and prosodic features such as pitch, tone, and/or rhythm features, for example, are conveyed through acoustic tokens that capture the other speech/environmental segments and/or prosodic features that may detect a user's environment and/or user's emotional state. The tokens simplify the speech data into smaller manageable components that are easily processed by neural networks and other artificial intelligence.

One or more subsequent algorithms in the exemplary human-to-machine application refine the lossy compression without further data losses before the processed speech is transmitted to a client or a destination. The one or more subsequent algorithms may comprise a non-destructive encoder that may detect one or more data/content patterns and/or one or more data/content redundancies that can be deleted and/or replaced with shorter strings of data/content (e.g., via a Huffman coding, dictionary coding, etc.). The replacements reduce file sizes without eliminating data or the content it contains. The subsequent algorithms reduce the bitstream used to transmit speech, the memory required to store speech, the bandwidth required to convey speech coding, and the delay associated with reassembling the speech at a client and/or a destination.

In a machine-to-human application, the tiered compression system may be implemented in a distributed architecture like the human-to-machine application. In an exemplary machine-to-human distributed architecture, client-side components, like mobile phone components that are part of the front end, interact with remote components, such as those hosted on a cloud server that independently handle speech coding and compression. One or more cloud servers communicate with clients by delivering a compressed output, but its core functionality is decoupled from the client side ensuring scalability and robustness in processes that are offloaded from the remote client front end, thereby freeing up processing capacity. The speech coding compressions occurring in the cloud may map sounds in a way that aligns with human hearing and represent a frequency range, such as the human hearing spectrum (that lies in about 20 Hz to about 20 KHz). The remote components may include a decoder that converts the coded and compressed data back to spectrograms that are then converted into a readable text. Vocoders may then convert the readable text to human-like audible speech.

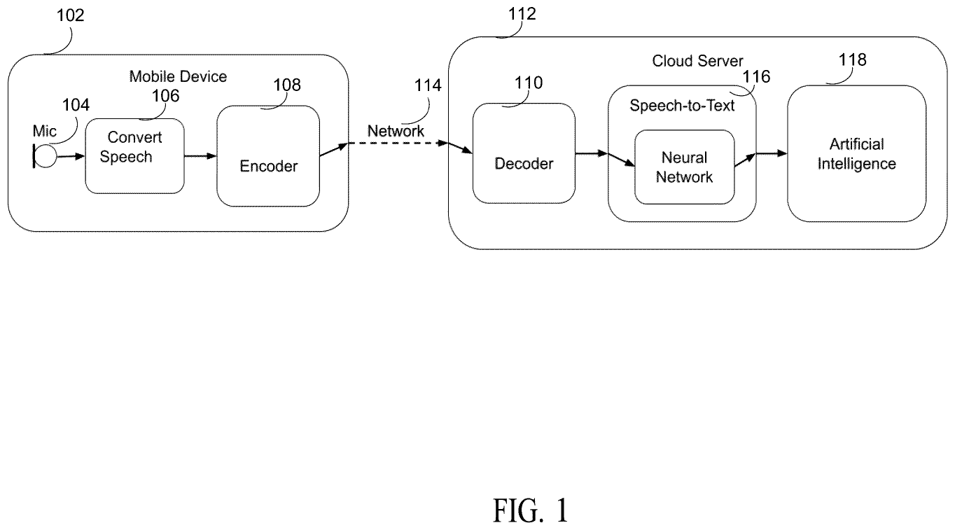

In an exemplary human-to-machine application shown in FIG. 1, the conversion from speech to text (or in a more abstract form speech tokens) includes a front end mobile device 102 that compresses a voice signal into a representation with lower dimensionality. Instead of directly encoding the voice signal, the tiered compression system encodes a compressed representation of the voice signal. Some human-to-machine applications include a tokenizer module (not shown) that generates acoustic tokens that artificial intelligence models process, analyze, and use to manipulate speech. Acoustic tokens may represent sounds (phonemes) words, syllables, and/or acoustic features including those described herein depending on the speech-to-text engine and emotion detections. The speech tokenizer module recognizes words and extracts other characteristics like emotion or speaker identity, for example, rather than striving for perceptual fidelity, which minimize word error rates.

An exemplary tokenizer module converts continuous speech waveforms into discrete tokens that can be processed by a downstream cloud or remote destination. The process may begin with a signal pre-processing, where an input waveform is sampled and segmented into overlapping frames with a stride that may be in the milliseconds. Each frame may be transformed into a frequency-domain representation using techniques such as the Mel-Frequency Cepstral Coefficients (MFCCs), producing a spectrogram-like feature space that captures energy distribution over time and frequency. A neural encoder (that may be a convolutional or transformer model, for example) is trained to map these continuous features into a compact latent space optimized for capturing data representing emotions and/or speaker identifications.

To make the representations discrete, an exemplary vector quantization or code-book based methods may be applied, assigning each frame or latent segment to the nearest entry in a learned dictionary of tokens. The tokens may be trained to preserve data representing phonetic content (e.g., words and phonemes) but also paralinguistic cues such as prosody, emotion, and/or speaker identity, that may vary with the system's application. Unlike perceptual audio codecs that may optimize the fidelity to the original waveform, an exemplary tokenizer module may be optimized for information preservation relevant to the recognition of tasks (e.g., maximizing the emotion classification accuracy). The output may comprise a sequence of discrete tokens that retain speaker related features for downstream tasks in a cloud or a remote site like speaker verification and/or emotion recognition. In some alternate systems, the tokenizer module may interface or be a unitary with a non-linear encoder and/or a non-destructive encoder that may be part of the mobile front end 112.

In FIG. 1, a microphone 104 converts spoken words into analog signals, which in some applications are converted into digital data and in some applications, processed to remove echoes and noise by echo cancellers and/or noise cancellers. A digital signal processor in the form of a non-linear encoder 106 such as a Melody (i.e., Mel) signal processor converts the raw spoken data into a spectrogram such as a Mel spectrogram representation at the front end client represented as a mobile device or mobile front end 102. The spectrogram represents the energy of an utterance or the spoken words across time and frequency. An exemplary Mel signal processor calculates the spectrogram by windowing the speech signal at periodic intervals, computing Fourier transforms (e.g., Fast Fourier Transforms or FFTs), measuring the energies of the Fourier bins, combining Fourier bins with triangular windows or filtering into frequency bins such as Mel bins of lower frequency resolution or predetermined perceptually important frequency bands, for example, and/or outputting bands or converting the bin's energies into another domain such as the logarithmic domain, for example. The compression of higher frequencies accentuates and emphasizes the lower frequencies, making the representation more perceptually relevant. An exemplary Mel spectrogram may be sampled in steps of about ten milliseconds rendering about eighty to about one hundred and twenty Mel bins that represents the aural spectrum.

The conversion of speech into one or more spectrograms deduces information. The conversion removes or deletes phase information (e.g., phase data) and combines multiple frequency bins. The removal and non-linear combination of bins lowers the dimensionality of the speech signal representation when compared to the original speech signal rendering a compressed domain. In FIG. 1, an encoder 108 converts the compressed domain into a bitstream that is transmitted to the decoder 110 hosted in a remote site or a cloud server 112, for example, remote from the front end mobile device client 102.

The reduced bit rate of the bitstream from the compressed domain is transmitted over a transmission channel, shown as a network 114 by the encoder 108 such as an exemplary Mel encoder. The decoder 110, such as an exemplary Mel decoder, for example, transforms the encoded signal into one or more spectrograms (e.g., one or more Mel spectrograms), which is then transmitted to an automatic speech recognition engine 116 in the form of a neural network that may be driven by or controlled by artificial intelligence 118. Artificial intelligence 118 includes processing engines, neural networks for learning and making predictions, and components that handle the data processing, learning, and machine interactions). The automatic speech recognition engine 116 recognizes words and/or phonemes. Deep learning models, such as recurrent neural networks, process the spectrograms to convert the spectrograms into text that may then be post-processed. In FIG. 1, the artificial intelligence 118 processes the words and/or phonemes recognized by the speech-to-text engine of the automatic speech recognition engine 116.

In FIG. 1, the core functionality of the remote site and/or cloud server 112 is decoupled from the remote front end mobile client 102 to improve scalability and robustness of the tiered compression system. By decoupling the decoder 110 (e.g., the Mel decoder) and automatic speech recognition engine 116 from the front end mobile device client 102, the tiered compression system frees up mobile processing resources and time, allows for the scaling up or down of computing resources, provides flexibility and accessibility to other remote clients, and optimizes performance as the cloud server 112 comprises a server cluster that may distribute loads through one or more load balancers across multiple cloud servers mitigating bottlenecks that may occur during peak processing periods. A server cluster comprises a group of independent computers that work together as a single system but present the appearance of a single server to a client.

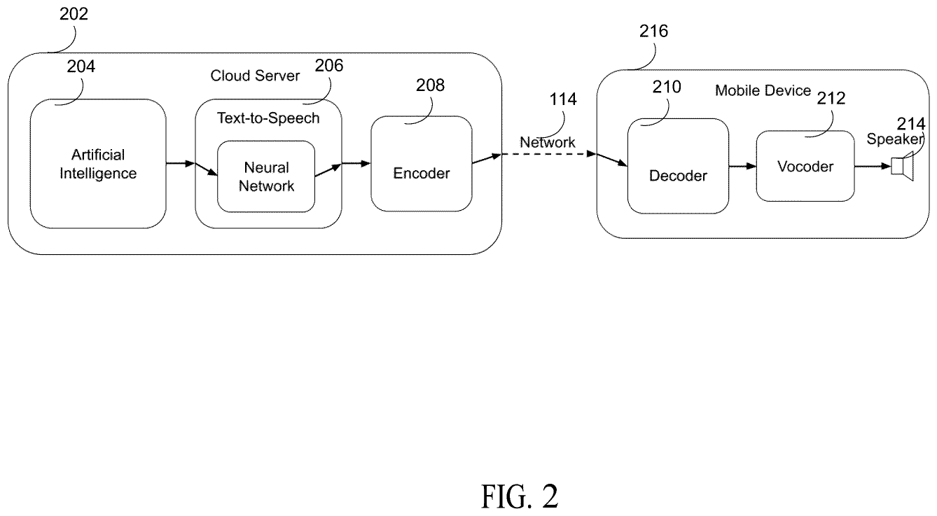

In FIG. 2 the cloud servers 202 and load balancers (e.g., the server cluster) host an artificial intelligence module 204, such as a Large Language Model (LLM) module for example that understands and manipulates speech. Using a transformer-based-architecture, the LLM may generate text, perform translations, provide summaries, and respond and/or answer questions. In FIG. 2, natural language text generated by the LLM is converted into speech in an aural frequency range of a human user by a text-to-speech engine 206. The raw speech is converted into a spectrogram, such as a Mel spectrogram or Bark spectrogram using Short Time Fourier transforms and filters (e.g., a filter bank such as a Mel filter bank). The spectrogram comprises a time-frequency representation where the horizontal axis in a two dimensional space comprises time and the vertical axis comprises frequency mapped to a perceptual scale. The perceptual scale may imitate human hearing by spacing frequency bins in a way that emphasizes lower frequencies (where human hearing is more sensitive) while compressing higher frequencies (where human hearing is less sensitive). In FIG. 2, the non-linear scale renders features that are perceptible to hearing while reducing the data load. In an exemplary system, the perceptual scale comprises a Mel scale or a Bark scale, for example.

In some exemplary decoders, the filter maps the linear frequencies generated by the Short Time Fourier transforms to the perceptual scale. This compresses the higher frequencies making the lower frequencies more prominent. It emphasizes the lower frequencies making the representations more perceptually relevant. The compression may comprise a logarithmic scale, which arbitrates intensity variations between different sounds. The output may comprise a two-dimensional matrix with the horizontal axis comprising time and the vertical axis represents frequencies to the desired perceptual scale, such as a Mel or Bark scale, for example, rendered by the non-linear encoder rendered through the neural network. In FIG. 2, the matrix (e.g., a form of the spectrogram) is encoded into a bitstream by the encoder.

In some alternate tiered compression systems (not shown), the encoder 208 may include or comprise a neural network that generates acoustic tokens that represent linguistic units such as phonemes, sub-words, emotions, speaker identities, and/or whole words, for example. The sequence of text or word tokens are transmitted by the decoder over a transmission channel, shown as a network 114, and then detokenized by a detokenization module that may be a unitary part of or interface the decoder 210 before converting them back to one or more spectrograms, such as the Mel or Bark spectrogram, for example. A detokenization module in this alternate system may comprise a processor and in some system is part of the decoder 210. The detokenization module converts acoustic tokens into acoustic features of speech, which may comprise a one or more spectrograms and/or one or more modification of spectrograms. A vocoder 212 then converts the one or more spectrogram into audio frames that are converted into audible sound by a loudspeaker 214. In another alternate system, a neural vocoder generates speech signals from acoustic tokens directly from the intermediate representations, such as the spectrograms.

In FIG. 2, the bitstream conveyed by a transmission channel, shown as a network 114, to the mobile client device 216 (referred to as the mobile client device front end). The bitstream is decoded generating spectrogram frames (such as Mel or Bark spectrogram frames), which are then converted into audio frames by the vocoder 212. The loudspeaker 212 converts the audio frames into audible sound.

In this disclosure, when functions are “responsive to” or occur “in response to” another function or step, etc., the functions or steps necessarily occur as a result of another function or step, etc. A system or process that is responsive to another requires more than an action (i.e., the process and/or device's response to) merely follow another action.

In FIG. 2, the final stage of the cloud servers 202 processing converts a compressed internal representation of the voice signal. Here, encoding the compressed representation of the voice signal is more efficient than encoding a final voice signal. Further, the conveyed signal is voice exclusively absent other sounds like background noise or music, for example. This allows the encoding process in FIG. 2 to be optimized and maximizes the fidelity of the final speech output signal.

In this disclosure the term “substantially” or “about” encompasses a range that is largely in some instances, but not necessarily wholly, that which is specified. It encompasses all but a significant amount, such as what is specified or within five to ten percent. In other words, the terms “substantially” or “about” means equal to or at or within five to ten percent of the expressed value. Forms of the term “cascade” and the term itself refer to an arrangement of two or more components such that the output of one component is the direct input of the next component (e.g., in a series connection). The term “unitary” refers to an indivisible entity, oneness, and singularity. It refers to a single indivisible entity or component. The term engines comprise a processor or a portion of a program such as an application or software stored on a non-transitory computer media that executes one or more functions, such as sequential or multiple data compressions, converting speech-to-text, converting text-to-speech, recognizing speech automatically (e.g., via an automatic speech recognition engine), etc. An engine refers to the core system or to the software that processes inputs (such as data or text) and generates outputs (like two or more data compressions, speech conversions, text conversions, speech recognitions) etc. and may include logic. The term cloud server refers to a network of remote servers (e.g., data centers) that provide storage, processing power, and services over a publicly accessible distributed network like the Internet. Instead of providing services locally (e.g., running software or storing data), those services are provided remotely via a network.

The tiered compression system and compression engine that render the disclosed functions herein may be practiced in the absence of any disclosed or expressed element (including the components, hardware, the software, and/or the functionality expressed), and in the absence of some or all of the described functions association with a process step or component or structure that are expressly described. The systems may operate in the absence of one or more of these components, process steps, elements and/or any subset of the expressed functions. Further, the systems may function with additional or substitute elements and functionality, too. For example, there may be more lossy and/or lossless compression stages.

Further, the various elements and system components, and functions described in each of the many systems and processes described herein are regarded as divisible with regard to the individual elements described, rather than inseparable as a whole. In other words, alternate systems encompass any variation and combinations of elements, components, and process steps described herein and may be made, used, or executed without the various elements described (e.g., they may operate in the absence of) including some and all of those disclosed in the prior art but not expressed in the disclosure herein. Thus, some systems do not include those disclosed in the prior art including those not described herein and thus are described as not being part of those systems and/or components and thus rendering alternative systems that may be claimed as systems and/or methods excluding those elements and/or steps.

The tiered compression systems transmit, store, manipulate, detect, processes and/or generate speech in a human-to-machine communication or a machine-to-human communication. The systems mitigate distortion and facilitate processing by targeting different aspects of speech through a hybrid combination of one, two, or more lossy compressions and lossless compressions. Using a cascade compression engine, the tiered compression system maps frequencies to a perceptual scale. The output may be tokenized by an optional tokenized module and then further compressed, packetized, and transmitted through a communication channel. The perceptual scale does not map frequencies in a proportional way so that the scale reflects human auditory perception. In other words, the scales segment sound into representations human users typically hear. In an exemplary use case, the perceptual scales comprise Mel scale and/or a Barker scale.

Other systems, methods, features, and advantages will be, or will become, apparent to one with skill in the art upon examination of the figures and detailed description. It is intended that all such additional systems, methods, features, and advantages be included within this description, be within the scope of the disclosure, and be protected by the following claims.

1. A human-to-machine transmission system having a mobile front end remote from a host, comprising:
the mobile front end comprising:
a non-linear encoder that converts data representing an utterance into a frequency spectrum representing an aural range of a human user; and
an encoder that converts an output of the non-linear encoder into a bitstream and transmits the bitstream to the host;
the host comprising:
a decoder that converts the bitstream into the frequency spectrum representing the aural range of a human user;
an automatic speech recognition engine that processes an output of the decoder to deliver an output of recognized words or phonemes from the utterance; and
artificial intelligence that post processes an output of the automatic speech recognition engine;
where the encoder includes a compression engine that deletes a plurality of prosodic data in a digital domain before transmitting one or more tokens via the bitstream to the host.

2. The system of claim 1, where the non-linear encoder converts a raw spoken data into the frequency spectrum by windowing the raw spoken data at a periodic interval and measuring energies of a plurality of bins.

3. The system of claim 1, where the prosodic data comprises data that identifies the human user's surroundings.

4. The system of claim 1, where the prosodic data comprises data that conveys the human user's emotions.

5. The system of claim 1, where the encoder comprises a non-destructive encoder that compresses the output of the non-linear encoder without a loss of information.

6. The system of claim 5, where the non-destructive encoder compresses a compressed data without deleting a content.

7. The system of claim 6, where the non-destructive encoder deletes one or more patterns of the content.

8. The system of claim 7 where the one or more patterns of the content are replaced with a shorter string of a content pattern.

9. The system of claim 1 where the non-linear encoder and the encoder comprise a tiered compression.

10. The system of claim 1, where the mobile front end comprises a mobile phone.

11. The system of claim 1 where the host comprise a cloud.

12. The system of claim 1 where the non-linear encoder comprises a digital processor that outputs a predetermined plurality of perceptual frequency bands.

13. The system of claim 1 where the non-linear encoder executes a framing process, a windowing process, a Fast Fourier Transform, a filtering, and a domain conversion.

14. The system of claim 13 where the domain conversion deletes a phase data.

15. The system of claim 14 where the domain conversion combines a plurality of frequency bins.

16. The system of claim 1 where the automatic speech recognition engine is controlled by an artificial intelligence engine.

17. The system of claim 1 further comprising a tokenizer module that interfaces the non-linear encoder that renders data conveying a prosody of the human user.

18. The system of claim 17 further comprising a detokenization module that interfaces a decoder that interfaces the automatic speech recognition engine.

19. The system of claim 18 where the detokenization module converts a plurality of tokens into modifications of one or more spectrograms.

20. A machine-to-human transmission system having a mobile front end remote from a host, comprising:
the host comprising:
a language model that replies to inquiries;
a neural network in communication with the language model that converts text-to-speech through a text-to-speech engine;
a non-linear encoder that converts data representing a speech rendered by the text-to-speech engine into a frequency spectrum representing an aural range of a human user; and
an encoder that converts an output of the non-linear encoder into a bitstream and transmits the bitstream to the mobile front end;
the mobile front end comprising:
a decoder that converts the bitstream into the frequency spectrum representing the aural range of a human user; and
a vocoder that convers the frequency spectrum representing the aural range into audio frames; and
a loud speaker that converts the audio frames into an audible sound.

21. A machine-to-human transmission system having a mobile front end remote from a host, comprising:
the host comprising:
a language model that replies to inquiries;
a neural network in communication with the language model that converts text-to-speech through a text-to-speech engine;
a non-linear encoder that converts data representing a speech rendered by the text-to-speech engine into a frequency spectrum representing an aural range of a human user; and
an encoder that converts an output of the non-linear encoder into a bitstream and transmits the bitstream to the mobile front end;
the mobile front end comprising:
a decoder that converts the bitstream into the frequency spectrum representing the aural range of a human user; and
a vocoder that converts the frequency spectrum representing the aural range into audio frames; and
a loudspeaker that converts the audio frames into an audible sound;
where the non-linear encoder comprises a neural network that generates acoustic tokens that represent linguistic units of the speech rendered by the text-to-speech engine.
